(19) United States
(12) Patent Application Publication
(10) Pub. No.: US 2022/0317089 A1
(43) Pub. Date: Oct. 6, 2022

(54) GAS CHROMATOGRAPH MASS SPECTROMETER AND MASS SPECTROMETRY METHOD

(71) Applicant: SHIMADZU CORPORATION, Kyoto-shi, Kyoto (JP)

(72) Inventor: Masato TAKAKURA, Kyoto-shi, Kyoto (JP)

(73) Assignee: SHIMADZU CORPORATION, Kyoto-shi, Kyoto (JP)

(21) Appl. No.: 17/597,015

(22) PCT Filed: Aug. 22, 2019
(86) PCT No.: PCT/JP2019/032873

§ 371 Date: Dec. 22, 2021

(51) Int. Cl. G01N 27/623; H01J 49/02; H01J 49/14; G01N 30/72

(52) U.S. Cl. CPC G01N 27/623; H01J 49/022; H01J 49/147; G01N 30/7206

(57) ABSTRACT

A gas chromatograph mass spectrometer includes a separator that separates a sample, and a mass analyzer that performs mass spectrometry on the sample introduced from the separator, the mass analyzer includes a filament and an ionization chamber into which thermal electrons from the filament and the sample from the separator are introduced, and an opening through which the thermal electrons emitted from the filament pass and which is formed in the ionization chamber or in a member arranged between the ionization chamber and the filament has a maximum diameter of less than 3 mm.

### TECHNICAL FIELD

The present invention relates to a gas chromatograph mass spectrometer and a mass spectrometry method.

### BACKGROUND ART

In an analysis performed by a gas chromatograph-mass spectrometer (GC-MS), a sample separated by a gas chromatograph (GC) is efficiently ionized, so that sensitivity can be increased. In electron ionization (EI), a sample introduced into an ionization chamber is irradiated with thermal electrons emitted from a filament arranged outside of the ionization chamber, and the sample is ionized by a reaction with the thermal electrons. There is a problem that if a current flowing through the filament is increased to increase the amount of the thermal electrons in order to achieve efficient ionization, the life of the filament is reduced.

A device configuration that improves performance of the GC-MS using EI is proposed. In Patent Document 1, an entrance of thermal electrons for EI is formed to be larger than that of thermal electrons for chemical ionization (CI). In Patent Document 2, it is proposed that a filament is placed at a position that is apart from an ionization chamber and at which an electric field formed between the filament and an electron entrance does not affect the interior of the ionization chamber.

### CITATION LIST

[Patent Document]

[Patent Document 1] JP 62-129760 A

[Patent Document 2] JP 4692627 B2

### SUMMARY OF INVENTION

### Technical Problem

A further device configuration is desirably proposed to increase ionization efficiency in the GC-MS.

### Solution to Problem

A first aspect of the present invention is directed to a gas chromatograph mass spectrometer including a separator that separates a sample, and a mass analyzer that performs mass spectrometry on the sample introduced from the separator, the mass analyzer includes a filament and an ionization chamber into which thermal electrons from the filament and the sample from the separator are introduced, and an opening through which the thermal electrons emitted from the filament pass and which is formed in the ionization chamber or in a member arranged between the ionization chamber and the filament has a maximum diameter of less than 3 mm.

A second aspect of the present invention is directed to a mass spectrometry method including separating a sample by a separator of a gas chromatograph mass spectrometer, and performing mass spectrometry on the sample introduced from the separator by a mass analyzer of the gas chromatograph mass spectrometer, and, in the mass spectrometry, in the mass analyzer, a current is flowed through a filament to cause thermal electrons to be emitted from the filament, and cause the emitted thermal electrons to pass through an opening that is formed in an ionization chamber or in a member placed between the ionization chamber and the filament, and to be introduced into the ionization chamber and then be ionized, the opening having a maximum diameter of less than 3 mm.

### Advantageous Effects of Invention

According to the present invention, efficiency of ionization can be increased in the GC-MS.

### BRIEF DESCRIPTION OF THE DRAWINGS

FIG. 1 is a conceptual diagram showing a configuration of a GC-MS of one embodiment.

FIG. 2 is a conceptual diagram showing an ionizer according to the one embodiment.

FIG. 3 is a flowchart showing a flow of a mass spectrometry method according to the one embodiment.

FIG. 4 is a conceptual diagram showing a configuration of an ionizer according to a modification.

FIG. 5 is a chromatogram obtained in a comparative example 1.

FIG. 6 is a chromatogram obtained in a comparative example 2.

FIG. 7 is a chromatogram obtained in an inventive example.

### DESCRIPTION OF EMBODIMENTS

Embodiments for carrying out the present invention will be described below with reference to the drawings.

### First Embodiment

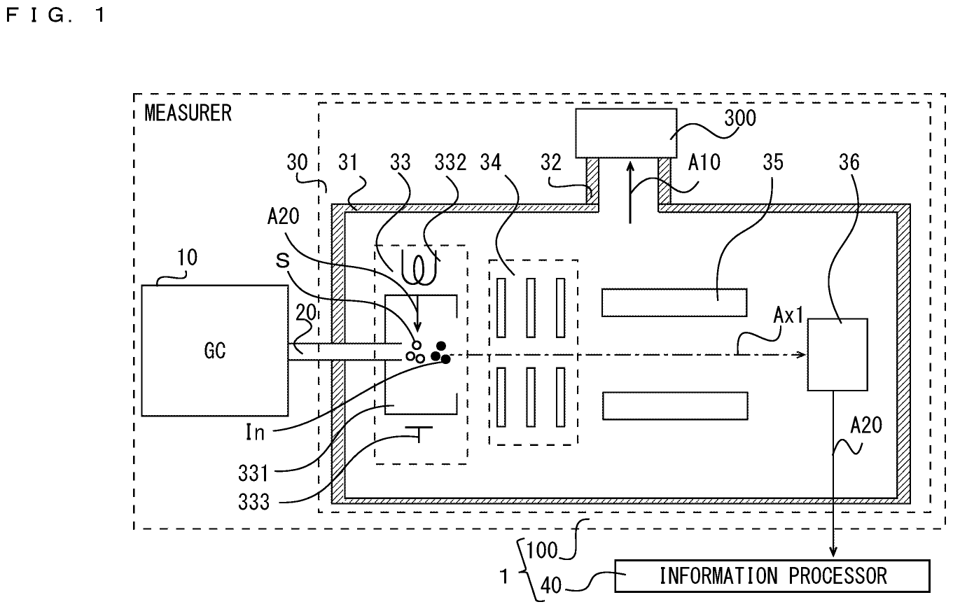

FIG. 1 is a conceptual diagram showing a configuration of a gas chromatograph-mass spectrometer (GC-MS) 1 of this embodiment. The GC-MS 1 includes a measurer 100 and an information processor 40. The measurer 100 includes a gas chromatograph (GC) 10, a sample introduction tube 20, and a mass analyzer 30. The mass analyzer 30 includes a vacuum container 31, an exhaust port 32, an ionizer 33 that ionizes a sample S to generate ions In, an ion adjuster 34, a mass separator 35, a detector 36, and a vacuum exhaust system 300. The ionizer 33 includes an ionization chamber 331, a filament 332, and a trap electrode 333.

The measurer 100 separates each component of the sample (hereinafter referred to as sample component) to detect each separated sample component.

The GC 10 separates the sample S introduced into the GC 10 by gas chromatography. A separation column not shown is attached to the GC 10 and separates the sample S. When the sample S is introduced into the separation column, the sample S is gas or in the form of gas. This is referred to as sample gas as appropriate. The type of the separation column is not limited in particular, and an arbitrary column such as a capillary column can be used. Each component of the sample gas separated in the GC 10 is eluted from the separation column at different times and is then introduced into the ionizer 33 of the mass analyzer 30 through the sample introduction tube 20. A method of coupling the GC 10 and the mass analyzer 30 is not limited in particular, and a method such as a direct coupling method, an open split method, a jet separator method or the like can be used.

The mass analyzer 30 includes a mass spectrometer and ionizes the sample S introduced into the ionizer 33, mass-separates the ionized sample S and detects the mass-separated sample S. Ions In derived from the sample S generated by the ionizer 33 moves along an ion optical axis Ax1.

It is noted that if the ions In derived from the sample S can be mass-separated and detected with a desired accuracy, the type of the mass spectrometer constituting the mass analyzer 30 is not limited in particular, and a mass spectrometer that includes an arbitrary type of one or more mass spectrometers can be used.

The vacuum container 31 of the mass analyzer 30 includes the exhaust port 32. The exhaust port 32 is connected to the vacuum exhaust system 300 such that air can be exhausted. The vacuum exhaust system 300 includes a pump in which a high vacuum of 10⁻² Pa or less can be achieved such as a turbo-molecular pump and an auxiliary pump thereof. In FIG. 1, a point at which gas within the vacuum container 31 is exhausted is schematically shown by an arrow A10.

The ionizer 33 of the mass analyzer 30 ionizes the sample S introduced into the ionizer 33 by electron ionization (EI). The sample introduction tube 20 is connected to the ionization chamber 331 such that the sample gas can be introduced into the ionization chamber. The sample S introduced into the ionization chamber 331 is irradiated with thermal electrons emitted from the filament 332. In FIG. 1, a flow of the thermal electrons is schematically shown by an arrow A20. The amount of the irradiated thermal electrons is detected by the trap electrode 333 arranged on the opposite side to the filament 332 with the ionization chamber 331 interposed therebetween.

When molecules included in the sample S and the thermal electrons come into contact with each other, the molecules included in the sample S are ionized, so that molecular ions are generated. In some cases, the molecular ions are cleaved and fragment ions are generated due to energy of the thermal electrons. The ions In derived from the sample S, which include the molecular ions or the fragment ions are emitted from the ionization chamber 331 by an electromagnetic action based on a voltage applied to an electrode arranged outside of the ionization chamber 331. For example, a voltage with a polarity opposite to that of the detected ions In is applied to the ion adjuster 34, and the ions In are accelerated by an extraction electric field based on the applied voltage.

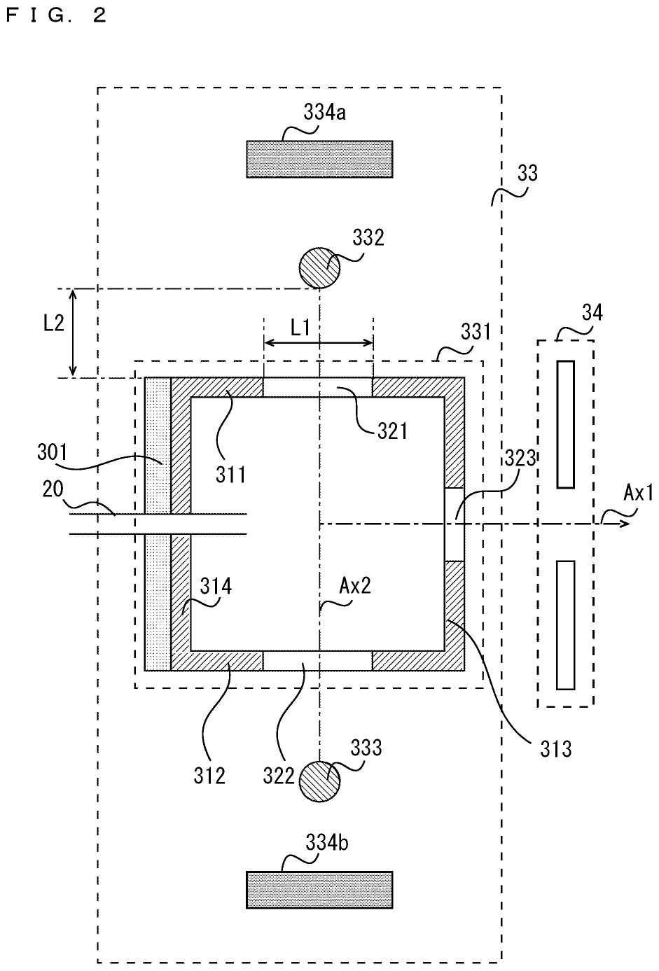

FIG. 2 is a conceptual diagram showing a configuration of the ionizer 33. A first opening 321 is formed in a first sidewall 311 of the ionization chamber 331. A second opening 322 is formed in a second sidewall 312 of the ionization chamber 331. The second sidewall 312 is formed at a position facing the first sidewall 311 with the ion optical axis Ax1 interposed therebetween. A third opening 323 through which the ions In generated by the ionization chamber 301 pass when emitted is formed in a third sidewall 313 of the ionization chamber 331. The sample introduction tube 20 is placed at a fourth sidewall 314 of the ionization chamber 331.

The first sidewall 311, the second sidewall 312, the third sidewall 313, and the fourth sidewall 314 are constituted by metal such as stainless steel. In order to accelerate the thermal electrons, a voltage of + several tens V is applied to the filament 332 in the ionization chamber 331 including the first sidewall 311. This voltage is appropriately set in terms of increasing efficiency of ionization. For example, the ionization chamber 331 is grounded so that the filament 332 can attain a potential of approximately −70V.

The ionization chamber 301 can be formed in a rectangular parallelepiped shape, a cylindrical shape or the like, for example. However, the shape of the ionization chamber 331 is not limited in particular if the thermal electrons emitted from the filament 332 can pass through the first opening 321 and be irradiated to the sample S, and the ions In obtained by this irradiation can be emitted from the ionization chamber.

The first opening 321 is an opening through which the thermal electrons emitted from the filament 332 pass when entering the interior of the ionization chamber 331. The second opening 322 is an opening through which the thermal electrons emitted from the filament 332 pass when emitted from the ionization chamber 331. The first opening 321 and the second opening 322 are formed with an axis Ax2 being a central axis. The axis Ax2 is preferably substantially orthogonal to the flow of the sample gas from the sample introduction tube 20 and the ion optical axis Ax1. Also, the sample introduction tube 20 is preferably arranged such that the flow of the sample S discharged from the sample introduction tube 20 passes through an intersection point of the axis Ax2 and the ion optical axis Ax1. The shape of the first opening 321 and the second opening 322 is not limited in particular if ionization can be performed with a desired efficiency. For example, the first opening 321 and the second opening 322 can be formed in a circular shape, an elliptical shape, a square shape or a rectangular shape.

Let a maximum value of an inner diameter of the first opening 321 be a first maximum diameter L1. The first maximum diameter L1 can be a length of a longest line segment of line segments that are perpendicular to the axis Ax2 and pass the axis Ax2 and two points of an inner wall of the first opening 321. The inventor found that if the first maximum diameter L1 of the first opening 321 is set to an appropriate value, ionization can be more efficiently performed without increasing a current in the filament to accelerate deterioration of the filament. Also, the first maximum diameter L1 is preferably less than 3 mm, more preferably less than 2 mm, and still more preferably 1.5 mm or less. If the first maximum diameter L1 is set to be smaller, density of the thermal electrons introduced into the ionization chamber 331 is increased and more efficient ionization is implemented.

If the first maximum diameter L1 of the first opening 321 is too small, positional deviation of each of parts such as the filament 332, the first opening 321, and the sample introduction tube 20 when the ionizer 33 is assembled causes a considerable decrease in ionization efficiency. Thus, the first maximum diameter L1 is preferably 1 mm or more. Also, the first maximum diameter L1 is preferably larger than an inner diameter of a column for use in order to prevent the decrease in ionization efficiency. In a case where the ionizer 33 is configured to be switchable between EI and CI, the first maximum diameter L1 is preferably larger than a maximum value of an inner diameter of an entrance of the thermal electrons for CI.

Let a length from the first opening 321 to the filament 332 measured along the axis Ax2 being the central axis of the first opening 321 be a first filament distance L2. The first filament distance L2 is preferably 1 mm or more in terms of easily carrying out the assembly. Let a ratio of the first maximum diameter L1 to the first filament distance L2 be L1/L2. L1/L2 is preferably less than 3, more preferably less than 2, and still more preferably 1.5 or less in terms of increasing the density of the thermal electrons introduced into the ionization chamber 331, similarly to the aforementioned case where the first maximum value L1 is appropriately set. Also, L1/L2 is preferably 1 or more in terms of inhibiting the decrease in ionization efficiency due to the positional deviation of each part of the ionizer 33 during the assembly.

When the first maximum diameter L1 is smaller, the decrease in ionization efficiency due to the positional deviation of each part of the ionizer 33 as described above is inhibited, so that a current flowing through the filament 332 can be adjusted to an appropriate value.

For example, after the GC-MS 1 is assembled during manufacture, repair or the like of the GC-MS 1, a manufacturer, a repairer or the like detects an arbitrary sample such as a standard sample by mass spectrometry by the mass analyzer 30 while changing the current flowing through the filament 332. In this detection, a first current value being the value of the current flowing through the filament 332 in the case of the highest sensitivity is acquired. The first current value is transmitted to a user of the GC-MS 1 (hereinafter referred to simply as “user”) by arbitrary means such as documents, communication or the like. When the user measures the sample S as an analysis target by the GC-MS 1, the user makes an adjustment such that the current flowing through the filament 332 is at a value equal to or close to this first current value. This makes it possible to inhibit an influence exerted on ionization efficiency due to the positional deviation of each part of the ionizer 33 during the assembly.

Alternatively, in place of the first current value in the aforementioned detection, a second current value being a current value flowing through a trap current 333 in the case of the highest sensitivity may be acquired. The second current value is transmitted to the user by arbitrary means such as documents or communication. In this case, the user monitors the current flowing through the trap electrode 333 and adjusts the current flowing through the filament 332 such that the current flowing through the trap electrode 333 is at a value equal to or close to the second current value. In this case also, it is possible to inhibit the influence exerted on the ionization efficiency due to the positional deviation of each part of the ionizer 33 during the assembly.

While the trap electrode 333 can be an arbitrary electrode that can detect thermal electrons, the trap electrode 333 preferably includes a filament. The trap electrode 333 is electrically connected to an ammeter, etc. not shown and is configured to be capable of measuring the amount of thermal electrons that arrive at the trap electrode. Assuming that the trap electrode is a filament, EI can also be carried out with this filament used as a thermal electron source and the filament 332 used as a trap electrode. In this case, the filament 332 and the trap electrode 333 are preferably in the same shape. Furthermore, a maximum value of an inner diameter of the second opening 322 and a distance between the second opening 322 and the trap electrode 333 as the filament are also preferably set similarly to the first maximum diameter L1 of the first opening 321 and the first filament distance L2 as described above.

The thermal electrons emitted from the filament 332 are moved along a spiral orbit by magnetic fields generated by magnets 334a and 334b arranged in the ionizer 33. Thus, the thermal electrons and the sample S can easily react with each other, and the ionization efficiency is increased.

A thermal conductor 301 includes a substance having electrical conductivity such as metal as a main component and is, for example, a block of aluminum. The thermal conductor 301 functions as a temperature adjuster that adjusts a temperature of the ionization chamber 331. The thermal conductor is arranged in contact with the ionization chamber 331 and a heat source such as a heater not shown. With a temperature of the heat source controlled, it is configured that the temperature of the ionization chamber 331 becomes close to a set temperature.

Returning to FIG. 1, the ion adjuster 34 of the mass analyzer 30 includes a lens electrode or an ion transport system such as an ion guide and adjusts ions In such as by converging a flux of ions In by an electromagnetic action. The ions In emitted from the ion adjuster 34 are introduced into the mass separator 35.

The mass separator 35 of the mass analyzer 30 includes a quadrupole mass filter and mass-separates the introduced ions In. The mass separator 35 allows the ions In to selectively pass therethrough based on a value of m/z in response to a voltage applied to the quadrupole mass filter. The ions In obtained by the mass separation by the mass separator 35 are incident on the detector 36.

The detector 36 of the mass analyzer 30 includes an ion detector and detects the incident ions In. The detector 36 causes an A/D converter not shown to A/D convert a detection signal obtained by the detection of the incident ions In to output a digitized detection signal as measurement data to the information processor 40 (the arrow A20).

The information processor 40 includes an information processing device such as an electronic computer and serves as an interface with the user, and also performs processing such as communication, storage, and calculation relating to various data. The information processor 40 acquires information as to analysis conditions, etc. from the user via an input device such as a keyboard or a touch panel. The information processor 40 includes a processing device such as a CPU (central processing unit) and a storage medium. The processing device executes a program stored in the storage medium and performs a key role of the operation of the GC-MS 1 such as controlling the measurer 100, processing measurement data and so on. A method of processing the measurement data is not limited in particular. Data corresponding to a chromatogram in which a retention time of ions In detected by the detector 36 and intensity of the detection signal are associated with each other can be created, and identification, quantitative determination or the like of molecules contained in the sample S can be carried out. The information processor 40 includes a display device such as a display monitor and displays information obtained by the processing by the processing device.

It is noted that the measurer 100 and the information processor 40 may be configured as an integrated device.

(As for a Mass Spectrometry Method)

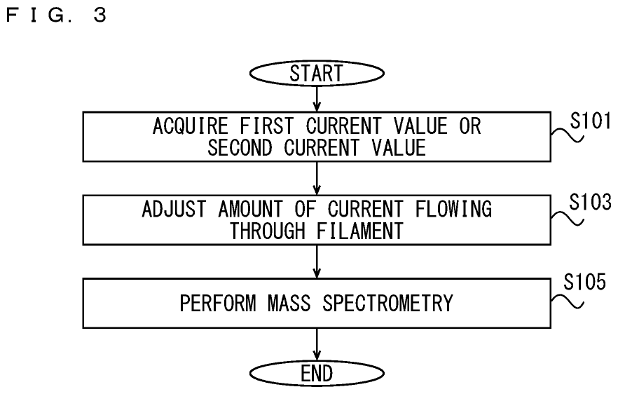

FIG. 3 is a flowchart showing a flow of a mass spectrometry method according to this embodiment. In step S101, the information processor 40 acquires a first current value or a second current value. This first or second current value may be stored in advance in the storage medium of the information processor 40 or may be input by the user. After step S101 is ended, step S103 is started.

In step S103, the information processor 40 adjusts the amount of the current flowing through the filament 332 based on the first current value or the second current value as described above. After step S103 is ended, step S105 is started. In step S105, the GC-MS 1 performs mass spectrometry on the sample S. After step S105 is ended, processing is ended.

A modification as shown below is also in the scope of the present invention and can be combined with the aforementioned embodiment. In the following modification, parts and the like indicating the same structures or functions as those of the aforementioned embodiment are referred to by the same signs and are not described as appropriate.

(Modification 1)

In the aforementioned embodiment, a member for making heat of the filament 332 unlikely to be transmitted to the ionization chamber 331 may be arranged between the filament 332 and the ionization chamber 331. When the temperature of the ionization chamber 331 is increased by a radiation heat from the filament 332, a degradant is produced on an inner wall of the ionization chamber 331, which causes noise. In the method of this modification, in addition to the effect of the aforementioned embodiment, this noise can be reduced. This member is hereinafter referred to as a shielding member. Please also see JP 4793440 B2 document for details of the shielding member.

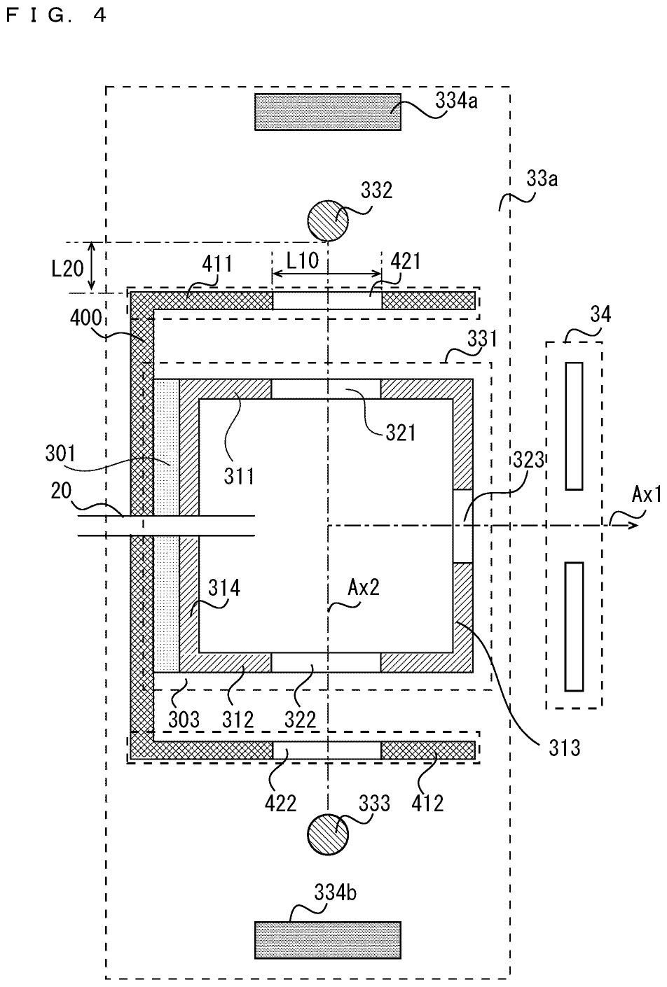

FIG. 4 is a conceptual diagram showing a configuration of an ionizer 33a of this modification. The ionizer 33a differs from the ionizer 33 of the aforementioned embodiment in that the ionizer 33a includes a shield 400. The shield 400 is constituted by a substance having electrical conductivity such as stainless steel and includes a first shielding member 411 and a second shielding member 412 that are arranged substantially in parallel. The shield 400 is arranged in contact with the thermal conductor 301. The shield 400 is electrically conductive with the ionization chamber 331 and thus attains the same potential as that of the ionization chamber 331. The first shielding member 411 and the second shielding member 412 are arranged to face each other with the ionization chamber 331 interposed therebetween. A fourth opening 421 is formed in the first shielding member 411, and a fifth opening 422 is formed in the second shielding member 412. The fourth opening 421 and the fifth opening 422 are formed with the axis Ax2 being the central axis. The shape of the fourth opening 421 and the fifth opening 422 is not limited in particular if the ionization can be performed with a desired efficiency. For example, the fourth opening 421 and the fifth opening 422 can be formed in a circular shape, an elliptical shape, a square shape or a rectangular shape.

Let a maximum value of an inner diameter of the fourth opening 421 be a second maximum diameter L10. The second maximum diameter L10 can be a length of a longest line segment of line segments that are perpendicular to the axis Ax2 and pass the axis Ax2 and two points of an inner wall of the fourth opening 421. The inventor found that if the second maximum diameter L10 is set to an appropriate value, ionization can be more efficiently performed. The second maximum diameter L10 is preferably less than 3 mm, more preferably less than 2 mm, and still more preferably 1.5 mm or less. If the second maximum diameter L10 is set to be smaller, density of the thermal electrons introduced into the ionization chamber 331 is increased and more efficient ionization is implemented.

If the second maximum diameter L10 is too small, positional deviation of each of parts such as the filament 332, the fourth opening 421, and the sample introduction tube 20 when the ionizer 33a is assembled causes a considerable decrease in ionization efficiency. Thus, the second maximum diameter L10 is preferably 1 mm or more. In a case where the ionizer 33a is configured to be switchable between EI and CI, the second maximum diameter L10 is preferably larger than a maximum value of an inner diameter of an opening through which the thermal electrons for CI pass.

Let a length from the fourth opening 421 to the filament 332 measured along the axis Ax2 be a second filament distance L20. The second filament distance L20 is preferably 1 mm or more in terms of easily carrying out the assembly. Let a ratio of the second maximum diameter L10 to the second filament distance L2 be L10/L20. L10/L20 is preferably less than 3, more preferably less than 2, and still more preferably 1.5 or less in terms of increasing the density of the thermal electrons introduced into the ionization chamber 331, similarly to the aforementioned case where the second maximum diameter L10 is appropriately set. Also, L10/L20 is preferably 1 or more in terms of inhibiting the decrease in ionization efficiency due to the positional deviation of each part of the ionizer 33a during the assembly.

Similarly to the aforementioned embodiment, when the second maximum diameter L10 is smaller, the decrease in ionization efficiency due to the positional deviation of each part of the ionizer 33a as described above is inhibited, so that a current flowing through the filament 332 can be adjusted to an appropriate value. In a case where the trap electrode 333 is used also as the filament for emitting the thermal electrons in EI, a maximum value of an inner diameter of the fifth opening 422 and a distance between the fifth opening 422 and the trap electrode 333 are also preferably set similarly to the second maximum diameter L10 and the second filament distance L20.

It is noted that the shape and the like of the shield 400 and the first shielding member 411 are not limited in particular if the fourth opening 421 is formed in the first shielding member 411 to make the heat from the filament 332 unlikely to be transmitted to the ionization chamber 331 to a desired extent.

(Aspects)

The above-mentioned plurality of exemplary embodiments or modifications are understood as specific examples of the below-mentioned aspects by those skilled in the art.

(Item 1) A gas chromatograph mass spectrometer according to one aspect includes a separator that separates a sample, and a mass analyzer that performs mass spectrometry on the sample introduced from the separator, the mass analyzer includes a filament and an ionization chamber into which thermal electrons from the filament and the sample from the separator are introduced, and an opening through which the thermal electrons emitted from the filament pass and which is formed in the ionization chamber or in a member arranged between the ionization chamber and the filament has a maximum diameter of less than 3 mm. Thus, efficiency of ionization can be increased.

(Item 2) In a gas chromatograph mass spectrometer according to another aspect, in the gas chromatograph mass spectrometer according to item 1, the maximum diameter of the opening is 1 mm or more. Thus, an influence exerted on the efficiency of ionization due to deviation of each part of an ionizer during assembly can be inhibited.

(Item 3) In a gas chromatograph mass spectrometer according to another further aspect, in the gas chromatograph mass spectrometer according to item 1 or 2, a ratio of the maximum diameter of the opening to a distance between the filament and the opening is less than 3. Thus, the efficiency of the ionization can be more reliably increased.

(Item 4) In a gas chromatograph mass spectrometer according to another further aspect, in the gas chromatograph mass spectrometer according to item 3, the ratio of the maximum diameter of the opening to the distance between the filament and the opening is 1 or more. Thus, the influence exerted on the efficiency of the ionization due to the deviation of each part of the ionizer during the assembly can be more reliably inhibited.

(Item 5) In a gas chromatograph mass spectrometer according to another further aspect, in the gas chromatograph mass spectrometer according to any one of items 1 to 4, the opening is configured such that the thermal electrons irradiated to the sample during electron ionization pass through the opening. In the EI, compared to another ionization, the amount of the thermal electrons irradiated to the sample is more likely to affect the ionization efficiency and, therefore, the ionization efficiency can be more effectively increased.

(Item 6) A mass spectrometry method according to one aspect includes separating a gas phase sample by a separator of a gas chromatograph mass spectrometer, and performing mass spectrometry on the sample introduced from the separator by a mass analyzer of the gas chromatograph mass spectrometer, wherein, in the mass spectrometry, in the mass analyzer, a current is flowed through a filament to cause thermal electrons to be emitted from the filament, and cause the emitted thermal electrons to pass through an opening formed in an ionization chamber or in a member placed between the ionization chamber and the filament and to be introduced into the ionization chamber and then ionized, and the opening has a maximum diameter of less than 3 mm. Thus, efficiency of ionization can be increased in a GC-MS.

(Item 7) In a mass spectrometry method according to another aspect, the mass spectrometry method according to item 6 includes adjusting the current flowing through the filament based on a current value set based on sensitivity of mass spectrometry performed after assembly of the gas chromatograph mass spectrometer. Thus, an influence exerted on the ionization efficiency due to deviation of each part of the ionizer during the assembly can be further reliably inhibited.

The present invention is not limited to the contents of the above-described embodiment. Another aspect considered to be within the scope of the technical idea of the present invention is also included in the scope of the present invention.

### [Inventive Example]

While an inventive example is shown below, the present invention is not limited to the inventive example shown below.

A sample containing 2,3,7,8-tetrachlorodibenzo-p-dioxin at a concentration of 50 ppt was analyzed by a gas chromatograph mass spectrometer (GC-MS).

The GC-MS used in the inventive example shown below is of a GCMS-TQ8050 type (Shimadzu Corporation) and has a configuration similar to FIG. 4. A shielding member is arranged between a filament that emits thermal electrons in EI and an ionization chamber, and an opening that allows the thermal electrons to pass is formed in the shielding member. A distance between the opening and the filament was 1 mm. In a comparative example 1, a maximum value of an inner diameter of the opening of the shielding member was 3 mm. In a comparative example 2, the GC-MS similar to that of the comparative example 1 was used, and an analysis was performed with the current flowing through the filament increased such that a current detected by a trap electrode (hereinafter referred to as emission current) was doubled. In the inventive example, the inner diameter of the opening of the shielding member was 1.5 mm in the GC-MS similar to that of the comparative example 1.

A measurement mode of the mass spectrometry in the inventive example shown below was multiple reaction monitoring (MRM). One fragment ion (referred to as first fragment ion) of detected fragment ions was mass-separated at m/z of 319.90 in a first stage and 256.90 in a second stage. Another fragment ion (referred to as second fragment ion) of the detected fragment ions was mass-separated at m/z of 321.90 in the first stage and 258.90 in the second stage.

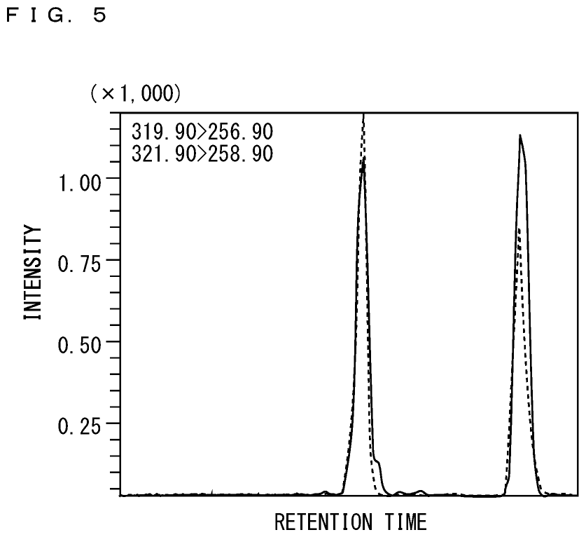

FIGS. 5, 6, and 7 are diagrams showing chromatograms obtained by the mass spectrometry in the comparative example 1, the comparative example 2, and the inventive example, respectively. In each of FIGS. 5, 6, and 7, data as to the first fragment ion was denoted by a solid line, and data as to the second fragment ion was denoted by a dashed line. Each of these chromatograms is a graph in which the abscissa indicates retention time and the ordinate indicates intensity of a detection signal of ions detected in the retention time. In FIGS. 5, 6, and 7, the intensity is not standardized and, therefore, the amount of the detected ions can be directly compared based on a value indicated by the ordinate of each chromatogram. The emission currents were 150 μA, 300 μA, and 150 μA, and the currents flowing through the filament were 3.29 A, 3.49 A, and 3.40 A in the comparative example 1, the comparative example 2, and the inventive example, respectively.

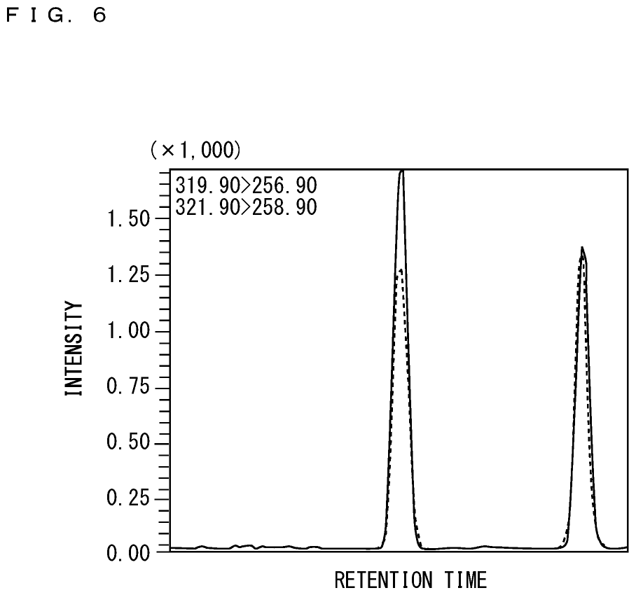

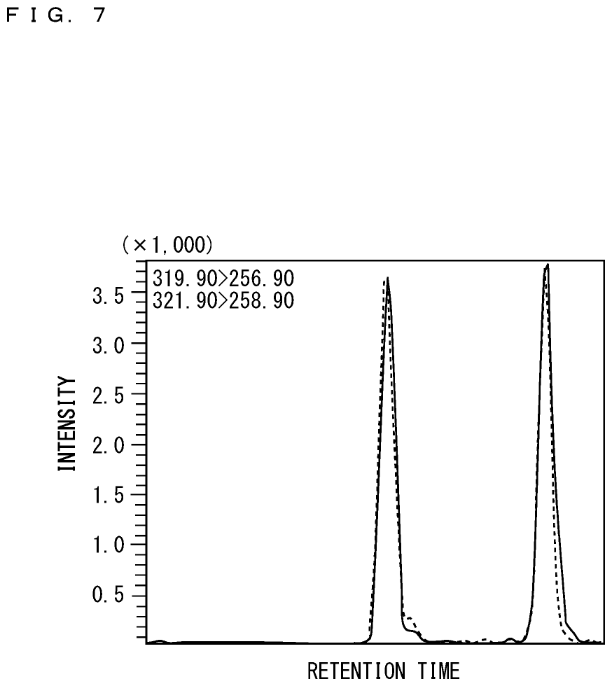

In the comparative example 1 of FIG. 5, a maximum intensity (in the unit of A.U.) of peaks corresponding to the sample was approximately 800 to 1200. In the comparative example 2 of FIG. 6, the maximum intensity of the peaks corresponding to the sample was approximately 1250 to 1700, and an increase in sensitivity due to an increase in the current flowing through the filament was observed. In the inventive example of FIG. 7, the maximum intensity of the peaks corresponding to the sample was approximately 3500 to 3800. In the inventive example of FIG. 7, the sensitivity was substantially increased as compared to the comparative example 1 irrespective of no change observed in the emission current as compared to the comparative example 1, and a considerably larger effect than the comparative example 2 was observed.

### REFERENCE SIGNS LIST

1 . . . GC-MS, 10 . . . GC, 20 . . . sample introduction tube, 30 . . . mass analyzer, 31 . . . vacuum container, 33, 33a . . . ionizers, 35 . . . mass separator, 36 . . . detector, 40 . . . information processor, 100 . . . measurer, 300 . . . vacuum exhaust system, 301 . . . thermal conductor, 311 . . . first sidewall, 312 . . . second sidewall, 313 . . . third sidewall, 314 . . . fourth sidewall, 321 . . . first opening, 322 . . . second opening, 323 . . . third opening, 331 . . . ionization chamber, 332 . . . filament, 333 . . . trap electrode, 400 . . . shield, 411 . . . first shielding member, 412 . . . second shielding member, 421 . . . fourth opening, 422 . . . fifth opening, Inion, S . . . sample.

1. A gas chromatograph mass spectrometer comprising:
a separator that separates a sample; and a mass analyzer that performs mass spectrometry on the sample introduced from the separator,
wherein the mass analyzer includes a filament, and an ionization chamber into which thermal electrons from the filament and the sample from the separator are introduced, and
an opening through which the thermal electrons emitted from the filament pass and which is formed in the ionization chamber or in a member arranged between the ionization chamber and the filament has a maximum diameter of less than 3 mm.

2. The gas chromatograph mass spectrometer according to claim 1, wherein the maximum diameter of the opening is 1 mm or more.

3. The gas chromatograph mass spectrometer according to claim 1, wherein a ratio of the maximum diameter of the opening to a distance between the filament and the opening is less than 3.

4. The gas chromatograph mass spectrometer according to claim 3, wherein the ratio of the maximum diameter of the opening to the distance between the filament and the opening is 1 or more.

5. The gas chromatograph mass spectrometer according to claim 4, wherein the opening is configured such that the thermal electrons irradiated to the sample during electron ionization pass through the opening.

6. A mass spectrometry method comprising:
separating a sample by a separator of a gas chromatograph mass spectrometer; and
performing mass spectrometry on the sample introduced from the separator by a mass analyzer of the gas chromatograph mass spectrometer,
wherein, in the mass spectrometry, in the mass analyzer, a current is flowed through a filament to cause thermal electrons to be emitted from the filament, and cause the emitted thermal electrons to pass through an opening formed in an ionization chamber or in a member placed between the ionization chamber and the filament and to be introduced into the ionization chamber and then ionized, and
the opening has a maximum diameter of less than 3 mm.

7. The mass spectrometry method according to claim 6, comprising adjusting the current flowing through the filament based on a current value set based on sensitivity of mass spectrometry performed after assembly of the gas chromatograph mass spectrometer.
